(19) United States
(12) Patent Application Publication
(10) Pub. No.: US 2022/0002517 A1
(43) Pub. Date: Jan. 6, 2022

(54) Conveyor Module Having Magnetically and X-Ray Detectable Fragments

(71) Applicant: Safari Belting Systems, Inc., Olathe, KS (US)

(72) Inventors: Christopher J. Smith, Leawood, KS (US); Julia H. Smith, Leawood, KS (US); Johnson C. Watkins, Newark, DE (US)

(73) Assignee: Safari Belting Systems, Inc., Olathe, KS (US)

(21) Appl. No.: 17/376,123

(22) Filed: Jul. 14, 2021

Related U.S. Application Data
(63) Continuation-in-part of application No. 17/206,663, filed on Mar. 19, 2021.
(60) Provisional application No. 62/991,872, filed on Mar. 19, 2020.

(51) Int. Cl. C08K 3/30; G01V 15/00; C08K 3/11; C08J 3/20

(52) U.S. Cl. CPC C08K 3/30; G01V 15/00; B29B 9/06; C08J 3/203; C08K 3/11

(57) ABSTRACT

A conveyer module, small fragments of which are detectable by X-ray and magnetic sensors, is formed from a compounded mixture of a polyketone, stainless steel powder, and barium sulfate powder. The thermoplastic polymer comprises a polyketone constituting less than 95.5% by weight of the mixture. The stainless steel constitutes at least 0.5% by weight of the mixture, and the barium sulfate constitutes at least 4% or more by weight of the mixture.

### CROSS-REFERENCE TO RELATED ART

This application is a continuation-in-part patent application of prior application Ser. No. 17/206,663, filed Mar. 19, 2021, which application claims the benefit of U.S. Provisional Application No. 62/991,872, filed Mar. 19, 2020, both of which applications are hereby incorporated herein by reference, in their entirety.

### TECHNICAL FIELD OF THE INVENTION

The invention relates generally to a conveyor system, and, more particularly, to a conveyor system in which conveyer modules are manufactured from a mixture of a thermoplastic polymer and, optionally, ferrous metal powder, small fragments of which module are X-Ray and/or magnetically detectable.

### BACKGROUND OF THE INVENTION

Low friction, wear resistant polymeric materials are used in modular plastic conveyor belt modules in numerous industries. In the meat and food product packaging industry, most conventional modular plastic conveyor belt modules are molded using polypropylene (“PP”), polyethylene (“PE”), or polyoxymethylene (“POM” aka acetal). The environment and use conditions of the conveyor dictate which polymer is best suited for a given conveyor. Environmental conditions include ambient temperature, temperature swings such as hot to cold-hot, humidity, immersion in liquid treatment baths, and chemical cleaning solutions. Use conditions can be described as speed of the conveyor, direction of travel and contact pressure of the conveyor belt module against contact surfaces. Conveyor belt modules are exemplified in U.S. Pat. No. 10,773,896 B1, issued on Sep. 15, 2020, to Chris Smith, which patent is incorporated herein by reference in its entirety.

Selecting the best polymer for a conveyor weighs the pros and cons of the interaction of that polymer with the conditions to which it will be subjected. For example, it is known to those skilled in the art that:
Polyamides, polyacetal and polyester have various coefficient of friction ratings which are ideal in sliding or rubbing applications like conveyors depending on product being conveyed.
Polyamides absorb 4-8% moisture and will swell in physical size with moisture.
Polyacetal is chemically degraded when exposed to low pH (or acidic) solutions.
PBT polyester chemically degrades in the presence of moisture above 80° C.

Among the many end use markets where polymeric conveyors are used is the food processing segment for both human and animal foodstuffs, referred to herein as the “protein market”. The protein market includes processing plants for the conversion of chickens, hogs, cattle, and fish into consumer products. Food safety to prevent foodborne illness and to prevent foreign material contamination is of utmost importance.

Recent advances in sanitizing techniques and sanitizing chemical agents have positively affected food safety but have had an adverse effect on the integrity and longevity of plastic conveyors. What has occurred is that the newer sanitizers now in use are lower in pH, and contain chemical oxidizers like hydrogen peroxide and peroxy acetic acid. Where before polyacetal was widely used as the polymer of choice in protein market conveyors, the rise of acidic oxidizers has rendered polyacetal nearly unusable because of its chemical incompatibility with both acidic agents and its high susceptibility to oxidative attack.

When polymers are chemically attacked, they lose their mechanical integrity, including tensile strength and impact resistance. Material science has described the loss of tensile properties and/or loss of impact resistance as embrittlement. A brittle polymer will fracture or shatter, generating small pieces of plastic debris, when external stresses are placed on it.

Conveyer modules manufactured from such polymers may, over time, through normal wear, cutting directly on modules, neglect, and/or by incidental impact, degenerate such that small fragments and particulates from the conveyor modules become integrated into the food products. These contaminants can be dangerous as choking hazards. If a piece of belt breaks off and gets into the food chain, the costs to the food processor can be in the 10's of millions of dollars. All the product from a particular production run must be recalled and disposed at the processor's expense. Recently, the USDA issued new guidelines for “foreign body contamination” recalls and the steps necessary to comply. The example the USDA used was what would happen if a piece of a modular plastic conveyor belt broke off and got into the food chain. This is a huge issue that is costing food companies billions of dollars each year.

Additionally, in industries such as pharmaceutical processing, the plastics may contain organometallic catalysts and plasticizers that can degrade the pharmaceutical product. Food contaminates such as wood and cloth and conveyor contaminates can be harmful to humans and/or animals that consume the meat or other food products.

Because it has been proven to be extremely difficult and inadequate to detect, by visual inspection alone, conveyor contaminate in meat and food being processed, food and drug regulations have been enacted to require metal and X-ray detection of conveyor fragments and other contaminants.

With the best available technology for magnetic and X-ray contaminate detection systems fully employed, there remains a need to improve the detectability of predictable process contaminates, such as conveyor systems fragments.

It is known to use magnetic metal detection for the identification of magnetic metal contaminates in food processing. However, many contaminates to processed food are non-magnetic. Conventional composite and plastic conveyor belt systems are non-magnetic. It is known to add magnetic steel powder with polypropylene and polyethylene resin to render the molded plastic conveyor fragments magnetically detectable.

Another way to detect conveyor fragments and particulate in meat and food being processed is by X-ray. However, X-ray is only effective if the X-ray image of the conveyor particulate is distinguishable from the meat or food product being conveyed. Therefore, it is necessary to include an X-ray opaque substance in sufficient proportions into the plastic conveyor resin to render a fragment of the conveyor X-ray detectable. Barium sulfate is known as an additive for use with polypropylene (PP) and polyethylene (PE) resin to render the molded plastic conveyor fragments detectable by X-rays.

It has recently been introduced to mix both powdered metal and barium sulfate as additives for use with polypropylene (PP) and polyethylene (PE) resin to render the molded plastic conveyor fragments both magnetically and X-ray detectable.

Each of these modified products, though magnetically and/or X-ray detectable, suffer from having significantly reduced performance characteristics that result from the combination of the barium sulfate and metal particles with the resin. In particular, these modified products are substantially more brittle. As a result, the detectable conveyor materials break easier and shed greater amounts of contaminant, and fail sooner than previous conveyor modules did.

In view of the foregoing, there continues to be a need for a plastic conveyor module that is both magnetically and X-ray detectable, and that has superior toughness

### SUMMARY OF THE INVENTION

The present invention, accordingly, provides a novel thermoplastic polymer that overcomes the serious drawbacks described above in the protein market conveyors. This new thermoplastic polymer, aliphatic polyketone, also referred to herein as POK, does not swell with moisture, is unaffected by aqueous low pH acids, and withstands exposure to peroxy acids with early immeasurable effect. In addition to an ideal chemical resistance profile of POK, this polymer has frictional properties that are superior to polyacetal, polyamides and polyester in protein market conveyors. Finally, the physical properties of POK including melting point, molecular weight, percent mold shrinkage, and degree of crystallinity enable POK to be used in existing injection molds, avoiding the need for expensive capital investment for new injection molds.

As is typical with many polymers, POK is produced in high, medium and low molecular weight ranges. In the protein market, it has been shown that high molecular weight POK provides the most desirable performance in friction, wear resistance, toughness retention, and high impact resistance. It is known to those skilled in the art that the melt flow rate of a polymer is inversely proportional to its molecular weight. Specifically, POK with a melt flow of less than 7 grams/10 minutes, measured at 240° C., performs well in protein conveyors, and it has been found that a POK polymer with a melt flow rate of 2-4 grams/10 minutes is the most optimal flow and molecular weight.

Further, POK does not become brittle after repeated exposure to the acidic peroxy sanitizers now used in the protein market. Therefore, POK conveyors do not generate small pieces of plastic when they break, which inherently contributes to higher confidence in preventing foreign matter contamination in food.

It has been found that a higher concentration of stainless steel powder, without barium, when added to the POK resin makes the belt modules both metal and X-ray detectable. This “single additive” also reduces the issue of increased brittleness of the belt module. The single additive also reduces cost to produce. A “1.5 mm ferrous equivalent” may be obtained for belt modules. This means that if a piece of belt breaks off, the detection equipment can detect a piece that is approximately as small as a 1.5 mm metal sphere.

The molding process has also been modified to adequately mold the parts. By way of example, but not limitation, the molding process has been modified to dry the resin prior to molding to properly mold the parts. The resin is preferably “compounded” prior to molding instead of being “batch mixed” with the stainless steel powder and possibly colorant in the molding machine. “Compounding” entails properly mixing the POK resin and the stainless steel powder into homogeneous pellets. Thousands of such pellets are then melted in the injection process to form one or more belt modules. The mold pressure, mold temperature, water temperature, and cycle times are adjusted to properly mold the parts.

An advantage of the various embodiments of the disclosed invention is that the modules of a conveyor system are both X-ray and magnetically detectable. Another advantage of the disclosed invention is that it is less expensive to manufacture than other products with this capability. Another advantage of the disclosed invention is that it provides a conveyor with a higher modulus of elasticity than other X-ray and magnetically detectable conveyor products.

Another advantage of the disclosed invention is that it provides a conveyor with a higher impact resistance than other X-ray and magnetically detectable conveyor products, and will therefore resist breaking and spalling on incidental contact. Another advantage of the disclosed invention is that it provides a conveyor with a higher chemical resistance than other X-ray and magnetically detectable conveyor products, as such conveyor products are exposed to harsh chemicals during cleaning operations.

Another advantage of the disclosed invention is that it provides a conveyor with a higher abrasion resistance than other X-ray and magnetically detectable conveyor products, and will therefore wear longer. Another advantage of the disclosed invention is that it provides a conveyor that requires fewer USDA approvals for food grade application component ingredients.

Another advantage of the disclosed invention is that it provides a conveyor with a wide operating temperature range, from 32° F.-305° F. Another advantage of the disclosed invention is that it provides a conveyor with a low adhesion factor to protein fat, fatty meat, and animal oils, which results in the conveyor remaining cleaner longer and being easier to clean than other plastics.

In a further embodiment of the invention, it has been found that barium sulfate may be added to the POK resin with the stainless steel powder to enhance X-ray detectability and, surprisingly, to significantly reduce the quantity of stainless steel required to render small fragments of a conveyor module to be magnetically and X-ray detectable. Unlike a combination of barium sulfate as an additive to polypropylene (PP) and/or polyethylene (PE) resin, which rendered a module brittle with reduced magnetic and X-ray detectability, as discussed above, adding barium sulfate to a POK resin has been found to enhance magnetic and X-ray detectability of a module fragment without rendering the module brittle.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart depicting steps at a high level for producing material for forming conveyor modules in accordance with principles of the invention.

FIG. 2 is a flow chart depicting, in greater detail, one step of the flow chart of FIG. 1 in accordance with principles of the invention.

### DETAILED DESCRIPTION OF THE PREFERRED EMBODIMENTS

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail.

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

It has been determined through extensive experimentation that a conveyor module can be produced that is both X-ray and magnetic detectable and that retains superior performance characteristics over conventionally known modules designed for this purpose. Such a conveyer module can be produced by forming same using a thermoplastic polymer, namely, a polyketone resin, such as produced by Hyosung Chemical in Seoul, South Korea, under the tradename of POKETONE®, also referred to herein as “POK”. A terpolymer polyketone is preferred, or, alternatively, an aliphatic polyketone may be used. It has been found that a terpolymer polyketone is preferred, comprising ethylene, carbon monoxide, and propylene in an approximate ratio of 47.5:47.5:5, respectively, in the polymer backbone. The propylene preferably constitutes 2% to 12% of the terpolymer polyketone, with the ratio of carbon monoxide to ethylene preferably being 1:1.

The preferred melt flow rate for the polyketone has been found to be 2.5 g/10 minutes measured at 240° C., per ASTM D1238. Such a melt flow rate imparts an optimal balance of processability and mechanical toughness of the final article. Alternatively, the melt flow rate may vary in an operable range of 2.5-70 g/10 minutes, measured at 240° C., per ASTM D1238.

In a further embodiment of the invention, it has been found that the magnetic susceptibility and detectability of a small fragment of a conveyer module formed from POK resin may be enhanced by compounding a mixture of the POK resin with a 400 series stainless steel powder. POK resin has been found to accept higher weight percent of stainless steel additive compared to other plastics, and retains a higher percentage of mechanical properties with the metal added. The amount of stainless steel powder should be small enough so as not to materially affect properties associated with the function of the POK, but be large enough to alter the magnetic susceptibility of the conveyer module. Accordingly, in a preferred embodiment, the POK resin constitutes less than about 99.5% by weight of the mixture, and the 400 series stainless steel powder constitutes between about 0.5% and 92% by weight of the mixture. It has also been found that, by increasing the percent by weight of the 400 series stainless steel powder in the POK resin to at least 4.5%, and reducing the percent by weight of the POK resin in the mixture to less than 95.5%, both magnetic and X-ray detectability of small fragments of a conveyer module formed from POK resin may be enhanced.

In a further embodiment of the invention, it has been found that the X-ray detectability of small fragments of a conveyer module formed from POK resin may be enhanced by compounding a mixture of the POK resin with barium sulfate powder, preferably comprising barium sulfate particles about 1 micron in size. It has also been found that barium sulfate may be added to the POK without rendering the POK brittle, which is surprising since barium sulfate renders polypropylene (PP) resin and polyethylene (PE) resin brittle. The amount of barium sulfate powder should be small enough so as not to materially affect properties associated with the function of the POK, but be large enough to alter the X-ray detectability of the conveyer module. Accordingly, in a preferred embodiment, the POK resin constitutes less than about 96% by weight of the mixture, and the barium sulfate powder constitutes at least about 4% by weight of the mixture.

In a still further embodiment of the invention, it has been found that both the magnetic and X-ray detectability of small fragments of a conveyer module formed from POK resin may be enhanced by compounding a mixture of the POK resin with both a 400 series stainless steel powder and barium sulfate powder. The amount of stainless steel powder and barium sulfate powder should be small enough so as not to materially affect properties associated with the function of the POK, but be large enough to alter the magnetic susceptibility and X-ray detectability of the conveyer module. Accordingly, in a preferred embodiment, the POK resin constitutes less than about 95.5% by weight of the mixture, the 400 series stainless steel powder constitutes at least about 0.5% by weight of the mixture, and the barium sulfate powder constitutes at least about 4% by weight of the mixture.

The 400 series stainless steel powder is preferably one of 409 stainless steel powder or 430 stainless steel powder. The 409 and 430 stainless steel powders are preferred as they allow for the best balance of magnetic detection at the lowest weight percent in the polymer, while providing very good oxidation resistance. The 300 series stainless steel powder, which is traditionally not attracted to a magnet, could be used, but the loading (weight percent) would need to be increased to a minimum of 22%. To match 18% 400 series detection, 300 series would need to be added at 26% by weight. However, at 26% loading, both cost and mechanical performance are adversely affected. Iron powder works extremely well for magnetic detection, but is highly prone to oxidation (rusting) in use.

It has been found that POK having a melt flow rate in the range of 4-90 g/10 minutes measured at 240° C., per ASTM D1238, or preferably about 6 g/10 minutes, works better for compounding with stainless steel powder.

The stainless steel powder preferably has a particle size of about 100 mesh, or, alternatively, in the range of 100 mesh to 325 mesh. Larger particle size powders, e.g., in the range of 60-80 mesh (170-250 microns), will decrease mechanical impact incrementally compared to 100-325 mesh powders, while still imparting useful detectability qualities in both X-Ray and Metal Detection devices. Alternatively, ultra-fine particle sizes, less than 325 mesh, pose dust explosion and fire hazards for the compounder, as well as higher cost than larger size particles.

The various combinations of stainless steel powder with and without barium sulfate powder will be referred to herein collectively as an “additive”.

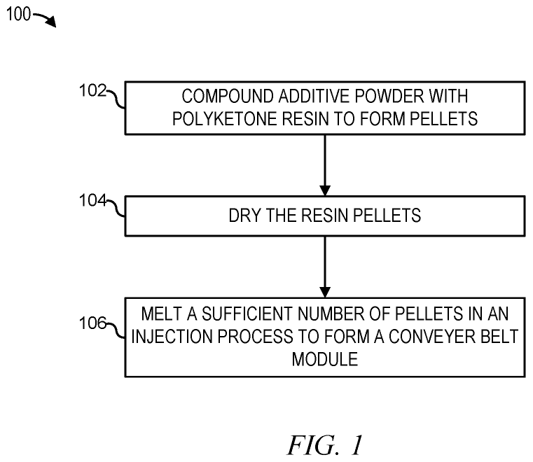

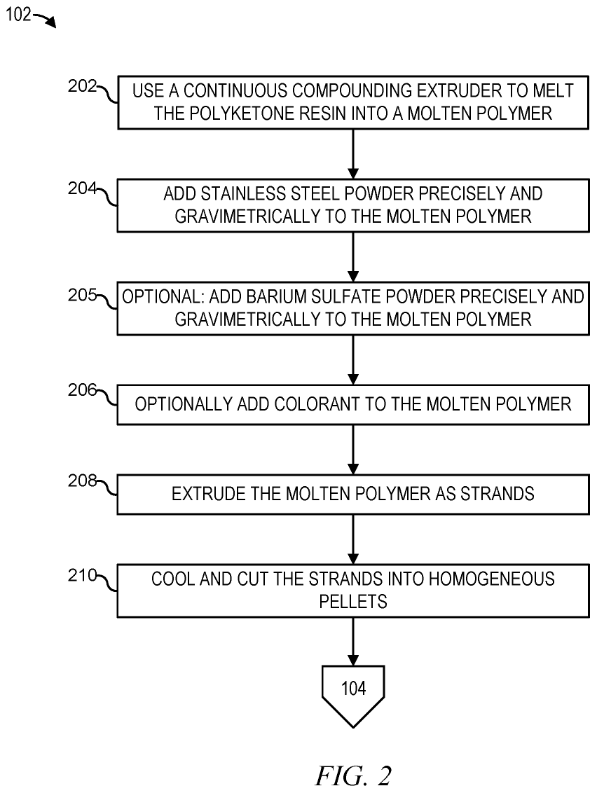

FIGS. 1 and 2 are flow charts 100 and 102 setting forth steps in a method for making a mixture of POK with an additive for use in forming conveyer modules. Accordingly, in FIG. 1, step 102, a given amount of an additive powder is preferably extrusion compounded into the POK resin to form homogeneous, cylindrical pellets, or the like. Extrusion compounding is preferred over injection molding because injection molding machines do not provide the same high degree of homogeneity in distributive mixing of additives into polymer. Also, phase separation readily occurs when trying to blend plastic resin and the considerably more dense additive. Further, injection molding machines do not allow for gravimetric addition of additives, like an extrusion compounder. Step 102 is described in further detail below with respect to FIG. 2.

In step 104, the resin pellets are dried prior to molding. Drying the resin, in a manner well-known to those skilled in the art, prior to molding is necessary for creating a blemish free exterior surface of the molded conveyor module.

The initial samples using POK having a melt flow rate of 2.5 g/10 minutes were molded into test coupons and exhibited exceptional strength and impact. But when conveyor modules were attempted to be molded, the compositions were so viscous that complete parts could not be formed, or the surface quality was too rough or the combination of heat pressure of the molding process caused the composition to chemically degrade.

Only when a high melt flow rate (i.e., greater than 2.5 g/10 minutes flow) POK was selected was it possible to make acceptable parts. The finished articles exhibited surprisingly high impact resistance and strength almost comparable to the POK without the additive.

In step 106, a number of pellets, sufficient to form a conveyer belt module, are melted in an injection process to form the conveyer belt module. The mold pressure, molding temperature, water temperature, cycle times, and other such parameters to perform this step are considered to be well-known to those skilled in the art, and so will not be described in further detail herein.

With reference to FIG. 2, flow chart 102 sets forth details of step 102 depicted above with respect to FIG. 1. Accordingly, in step 202, a twin screw, or optionally single screw, continuous compounding extruder is preferably used to melt POK resin into a molten polymer. In step 204, stainless steel powder, in quantities discussed above, is added precisely and gravimetrically to the molten polymer. In step 205, barium sulfate powder, in quantities discussed above, is optionally added precisely and gravimetrically to the molten polymer. Alternatively, prior to step 204, stainless steel powder and barium sulfate powder may be mixed and added together in step 204, rendering step 205 moot. In step 206, colorant is optionally added to the molten polymer. In step 208, the molten polymer is extruded as strands. In step 210, the strands are cooled and preferably cut (e.g., diced, chopped) into homogeneous pellets, which pellets are preferably cylindrical pellets. Execution then proceeds to step 104 (FIG. 1).

By use of the method described above with respect to FIGS. 1 and 2, conveyer modules may be formed, small fragments of which are detectable by X-ray and by magnetic sensors (e.g., Hall effect sensor, magnetometer, and the like) meeting a 1.5 mm ferrous calibration standard. Further, such modules have been shown to have high impact resistance, high abrasion resistance, high chemical resistance, and a low coefficient of product release.

It will be readily apparent to those skilled in the art that the general principles defined herein may be applied to other embodiments and applications without departing from the spirit and scope of the present invention. By way of example but not limitation, if magnetic detection is not needed, the additive may consist of barium sulfate powder (with no stainless steel powder) to thereby enable X-ray detection only.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A conveyor module, comprising:
a compounded mixture of a thermoplastic polymer, stainless steel, and barium sulfate;
wherein the thermoplastic polymer is a polyketone, the thermoplastic polymer constituting less than 95.5% by weight of the mixture;
wherein the ferrous metal is a 400 series stainless steel powder, the ferrous metal constituting at least 0.5% by weight of the mixture; and
wherein the barium sulfate constitutes at least 4% by weight of the mixture.

2. (canceled)

3. The conveyor module of claim 1, wherein the polyketone is one of an aliphatic polyketone and a terpolymer polyketone.

4. (canceled)

5. The conveyor module of claim 1, wherein the polyketone is a terpolymer polyketone comprising ethylene, carbon monoxide, and propylene in an approximate ratio of 45:49:6, respectively.

6. The conveyor module of claim 1, wherein the polyketone is a terpolymer polyketone comprising ethylene, carbon monoxide, and propylene, wherein the propylene constitutes from 2% to 12% of the terpolymer polyketone.

7. (canceled)

8. The conveyor module of claim 1, wherein the melt flow rate for the polyketone is 2.5-70 g/10 minutes measured at 240° C., per ASTM D1238.

9. The conveyor module of claim 1, wherein the stainless steel is a powder having a particle size of 100 mesh or smaller.

10. (canceled)

11. The conveyor module of claim 1, wherein the stainless steel is one of 409 stainless steel and 430 stainless steel.

12. The conveyor module of claim 1, wherein the barium sulfate is a powder having a particle size of about 1 micron.

13. A method of making a conveyer module, small fragments of which are detectable by X-ray and magnetic sensors, the conveyer module being formed from a polyketone resin, the method comprising compounding a 400 series stainless steel powder and a barium sulfate powder into the polyketone resin prior to formation of the conveyer module.

14. (canceled)

15. (canceled)

16. The method of claim 13, wherein the step of compounding comprises steps of:
using a twin screw continuous compounding extruder to melt the polyketone resin into a molten polymer;
adding stainless steel powder gravimetrically to the molten polymer; and
adding barium sulfate powder gravimetrically to the molten polymer.

17. (canceled)

18. The method of claim 13, wherein the step of compounding comprises steps of:
using a twin screw continuous compounding extruder to melt the polyketone resin into a molten polymer;
adding stainless steel powder gravimetrically to the molten polymer;
adding barium sulfate powder gravimetrically to the molten polymer;
adding colorant to the molten polymer;
extruding the molten polymer as strands; and,
cooling and dicing the strands into homogeneous cylindrical pellets.

19. The method of claim 13:
wherein the polyketone constitutes less than 95.5% by weight of the mixture;
wherein the 400 series stainless steel constitutes at least 0.5% by weight of the mixture; and
wherein the barium sulfate constitutes at least 4% by weight of the mixture.

20. (canceled)

21. The method of claim 13, wherein the polyketone is one of an aliphatic polyketone and a terpolymer polyketone.

22. (canceled)

23. The method of claim 13, wherein the polyketone is a terpolymer polyketone comprising ethylene, carbon monoxide, and propylene in an approximate ratio of 45:49:6, respectively.

24. The method of claim 13, wherein the polyketone is a terpolymer polyketone comprising ethylene, carbon monoxide, and propylene, wherein the propylene constitutes from 2% to 12% of the terpolymer polyketone.

25. The method of claim 13, wherein the melt flow rate for the polyketone is 4-90 g/10 minutes measured at 240° C., per ASTM D1238.

26. The method of claim 13, wherein the stainless steel is a powder having a particle size of 100 mesh or smaller.

27. (canceled)

28. The method of claim 13, wherein the stainless steel is one of 409 stainless steel and 430 stainless steel.

29. The method of claim 13, wherein the barium sulfate is a powder having a particle size of about 1 micron.

30. A conveyor module, comprising:
a compounded mixture of a thermoplastic polymer and stainless steel;
wherein the thermoplastic polymer is a polyketone, the thermoplastic polymer constituting less than 95.5% by weight of the mixture; and
wherein the ferrous metal is a 400 series stainless steel powder, the ferrous metal constituting at least 4.5% by weight of the mixture.

31-55. (canceled)
